(19) United States
(12) Patent Application Publication
(10) Pub. No.: US 2002/0072976 A1
(43) Pub. Date: Jun. 13, 2002

(54) Device and method for buying an item in a vending machine

(75) Inventors: Jyrki Virtanen, Helsinki (FI); Eero Heikkinen, Helsinki (FI)

Correspondence Address: KLARQUIST SPARKMAN, LLP, 121 SW SALMON STREET, SUITE 1600, PORTLAND, OR, 97204, US

(73) Assignee: Mecsel Oy, Semel Oy and Sonera Oyj

(21) Appl. No.: 09/957,562

(22) Filed: Sep. 19, 2001

Related U.S. Application Data
(63) Continuation of application No. PCT/FI00/00242, filed on Feb. 24, 2000.

(30) Foreign Application Priority Data
Mar. 25, 1999 (FI) 990660

(51) Int. Cl. G06F 17/60

(52) U.S. Cl. 705/16

(57) ABSTRACT

A payment instrument unit that can be connected to a vending machine, comprising a connecting member for connecting the payment instrument unit to the corresponding member of the vending machine, and a means of communicating with the vending machine by using a certain vending machine protocol, is characterized in comprising a first means that comprises a first data transmission device for receiving a contact request from wireless terminal equipment, and a second means comprising a second data transmission device for authenticating the user of the said wireless terminal equipment. The method for buying an item from a vending machine is characterized in that the contact request coming from the terminal equipment is transmitted to the payment instrument unit located in the vending machine, the contact request from the terminal equipment is received by the payment instrument unit at a certain stage of the purchasing transaction, the user of the said terminal equipment is authenticated, specification of the item to be bought is acknowledged by using the user interface of the vending machine, and the charging data are generated after the item has been specified.

The invention generally relates to buying items from vending machines. The invention relates to charging the buyer for the items bought from a vending machine in particular.

Depending on the prices of the items that are sold, vending machines use coins, banknotes, and token coins as means of payment. Furthermore, various cards, such as general-purpose cash and credit cards or cards distributed for certain purposes, such as telephone cards, can be used to pay for the items. Gradually, more and more smart cards are also used as means of payment Therefore, in order to make a successful purchase from a vending machine, the user must carry one of the means of payment mentioned above.

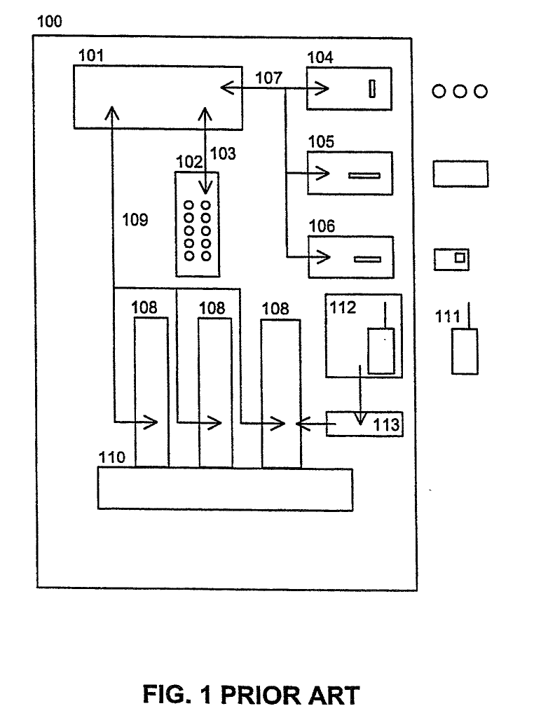

FIG. 1 shows one vending machine in accordance with prior art. Generally, vending machine 100 comprises central processor 101 that controls the other parts of the vending machine and, for example, collects statistical data about sales transactions. The central processor can be implemented, for example, in the form of a processor located on a certain motherboard, as a processor bus and connectors to which the other parts of the vending machine can be connected. The central processor is accountable for the actions in a purchase transaction to be carried out in the proper order. In possible error situations, for example, it ensures that the user does not receive a free item or that the user gets his or her money back, if the item is not delivered User interface 102 of the vending machine generally contains push buttons for the user to choose the item he or she wants. To facilitate the use of the vending machine, the push buttons of the user interface corresponding to the items the user can afford can be lit after the user has fed a certain amount of money into the vending machine. Generally, central processor 101 of the vending machine is responsible for the control and the activities of user interface 102 (shown by arrow 103).

The purpose of payment instrument units 104 to 106 is to receive the means of payment, identify them, notify the central processor of the vending machine after the required amount of money has been collected and, if coins, bank notes or token coins are used, to store these means of payment. Generally, there are as many payment instrument units as there are means of payment that are used. FIG. 1 shows, by way of an example, how payment instrument unit 104 handles coins, 105 bank notes, and 106 certain kinds of debit cards. Each payment instrument unit generally contains all the functions that are needed for paying by the means of payment in question, and the payment instrument units are typically connected to the motherboard of the central processor by a suitable cable and connectors. The connectors can be, for example, parallel ports or serial ports in accordance with certain standards. They all interact with the vending machine's central processor 101 by using the same protocol (shown by arrow 107 in FIG. 1); therefore, from the point of view of the central processor, the means of payment used does not affect the progress of the purchase. However, depending on the means of payment, the function induced by the protocol message ‘cancel charging’ can be different: cash is immediately returned to the user, debit and credit card charging data are not transmitted outside the vending machine, or any data already sent are corrected afterwards through a bank or the like and, as long as the card is still in the scanning device, any charges to smart cards can be immediately cancelled.

The items that are sold are located in item bays 108, which are controlled by the vending machine's central processor (arrow 109). When the payment instrument unit has stated the disposable balance and the user has, by pressing a push button, selected an item, the price of which does not exceed his or her disposable balance, central processor 101 gives a command to item bay 108 to drop the item into compartment 110, from where the user can take it. Should there be an error in delivering the item, the central processor receives an error notification from the item bay and can, for example, give the payment instrument unit a command to cancel debiting. Such an error situation can occur, if the mechanism of the item bay that releases the item is out of order, or an item has got stuck in the item bay.

In vending machines, there are two functional architectures in wide use: Executive and MultiDropBus (MDB). They differ in that, in the Executive system, each payment instrument unit operates as a deciding unit (master), and the rest of the vending machine operates as a sub-unit (slave). The payment instrument unit determines the pace of travel for the commands of the Executive protocol. In the MDB system, the central processor of the vending machine operates as the deciding unit, determining the pace of travel for the commands in accordance with the MDB protocol. The payment instrument unit interface in both systems is serial. An advantage of the MDB system is that the vending machine can have several payment instrument units (32 peripheral devices maximum). MDB and Executive are specified in the Vending Industry Data Transfer Standard (VIDTS).

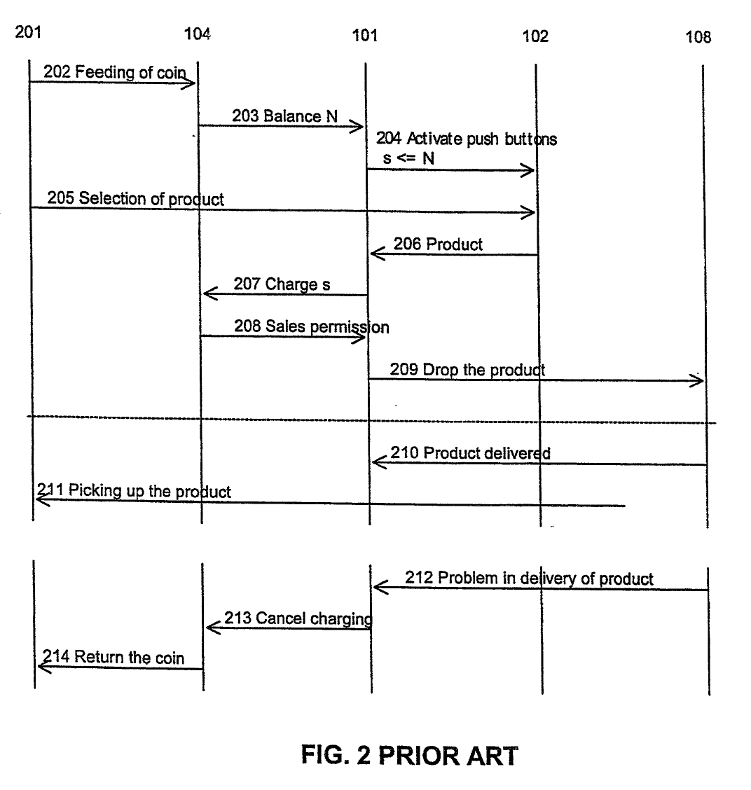

FIG. 2 essentially shows a typical progress of a purchasing transaction in the form of a chart where the arrows signify functions or protocol messages, and the vertical lines stand for the parts and users of the vending machine that are participating in the actions. The time order of the interactions runs from the upper edge of the FIG. to the lower end thereof. FIG. 2 shows the protocol messages only that are essential for the purchasing transaction. In the figures, the same reference numbers are used for the corresponding parts.

FIG. 2 shows, by way of an example, a purchasing transaction where coins are used as payment Arrow 202 shows how user 201 feeds a coin into payment instrument unit 104. By arrow 203, the payment instrument unit notifies the vending machine's central processor 101 of the available amount of money. In FIG. 2, the amount of money is marked by the letter N. Central processor 101 activates the push buttons of user interface 102 that can be used for buying the respective items with the amount of money (arrow 204), i.e., the items the prices (s) of which are smaller than or as large as N. The user pushes the desired push button (arrow 205) and information about the specified item is transferred from the user interface to the central processor by message 206. The central processor reads the price of the item from the table, for example, and sends charge request 207 to the payment instrument unit When the payment has been effected, the payment instrument unit notifies the control unit by using sales permission message 208. The central processor asks the goods bay to deliver the item (arrow 209) and indicates a successful delivery by message 210. When the user picks up the item (arrow 211, the front end of which, compartment 110, is not shown in FIG. 2), the purchasing transaction ends. Should the item not be delivered because of an error in the goods bay, for example, we would proceed from the dash line to the lower part of FIG. 2, so that an error notification 212 would be transmitted from the goods bay to the central processor, and, by using message 213, the central processor would notify the payment instrument unit of the cancellation of the charge. The payment instrument unit would return to the user an amount of coins equivalent to the price of the item, and the aborted purchasing transaction would end by the user taking back the coins (arrow 214).

In a solution according to prior art, making a telephone call to a chargeable service number can alternatively pay for the item. The user starts purchasing by calling from his or her telephone (symbol 111 in FIG. 1) to a service number that transmits 35 the call to telephone set 112 in the vending machine. The last digits of the service number specify the exact vending machine and the item the user is buying. There is a proper digit for each pair of an item and a vending machine, marked on the front panel of the vending machine, for example. The owner of the vending machine has agreed in advance with the teleoperator that the price of the call is the same as that of the item. To avoid extra fixed installations, the vending machine has telephone set 112, preferably comprising a cellular phone, and control unit 113 for the item bay installed therein. This item bay control unit is used to pass commands coming from the vending machine's central processor 101. The telephone set of the vending machine can be, for example, a so-called data GSM device that is used to transfer digital data across a GSM network (Global System for Mobile Communications). The telephone set comprises a logistics unit (not shown in FIG. 1) that takes care of answering the calls, for example.

Item bay control unit 113 is connected to telephone set 112. When a telephone call comes to the telephone number of an item, telephone set 112 answers the call and tells the item bay control unit 113 connected to the telephone number to produce, for example, a relay pulse that causes the delivery of the item from the item bay. Answering a call results in the creation of invoicing data, and the teleoperator sees to it that a telephone call to a chargeable number is entered into the user's telephone bill.

As the item bay control unit connected to the telephone set directly controls the operation of the item bay, the central processor of the vending machine in this prior art solution is passed Making statistics of purchases and processing error situations can be inadequate: for example, even if the item does not exist, the user must pay for the item, nonetheless, because a telephone call to a chargeable number is automatically entered into the telephone bill.

In the solution according to prior art, a telephone call to a certain number automatically causes delivery of an item, and a telephone charge of the size of the item's price is added to the telephone bill of the caller. A call to a wrong number mentioned in the vending machine thus results in delivery of a wrong item and payment for it Especially, if the telephone numbers connected with the items are successive or otherwise resemble one another; there can be a considerable likelihood to accidentally dial a wrong number. Furthermore, it is possible to use certain defects in the prior art solution for improper purposes. If call transfers to the number of the vending machine have not been prevented, all it takes is to direct the telephone calls that come to an ordinary telephone to the numbers that correspond to the items in the vending machine, and an outside caller ends up paying for items that are delivered to the vending machine compartment All it takes is for a swindler to occasionally go and check, if there are items in the compartment

Another problem in the prior art solution is that the data GSM device that the solution frequently uses is generally capable of using two telephone numbers. In the prior art solution, each item that can be bought from a certain vending machine by using a mobile station requires a telephone number of its own if we want to offer more than two items to be bought from a vending machine by using a mobile station, we have to either install several data GSM devices in this vending machine, or convert, in the telephone network, the telephone number connected with the item into a telephone number connected with this vending machine (so-called conversion of an A-number). Im the latter alternative, in order to deliver the desired item, possible extra logics are needed for the data GSM device in the vending machine to find out the original number.

The purpose of the invention is to present a versatile method for buying an item from a vending machine. Our objective is a method in which the buyer is charged for the price of the item and the buyer is authenticated with the intermediary of a mobile station or corresponding terminal equipment. It is preferable that any purchases according to the method are entered into the statistics of the vending machine and that the item that is bought is specified by the interface of the vending machine. Furthermore, it is preferable that, in the event of possible malfunction, it is possible to cancel charging the price of the item.

The object of the invention is achieved by a payment instrument unit that communicates with the vending machine's central processor by using the same protocol as the other payment instrument units, comprising a means of communicating with the buyer's mobile station and of authenticating the buyer, and making the necessary modifications between the messages travelling via the data communications network and the vending machine protocol used by the vending machine.

The payment instrument unit, according to the invention, connected to a vending machine, comprising a connecting member for connecting the payment instrument unit with the corresponding member of the vending machine, and a means of communicating with the payment instrument unit by using a certain vending machine protocol, is characterized in comprising a first means that comprises a first data transmission device for receiving a contact request from wireless terminal equipment, and a second means comprising a second data transfer device for authenticating the user of the said wireless terminal equipment.

The invention is also directed at a vending machine that comprises a user interface for specifying the item that is bought, a means of delivering the item, a corresponding member for connecting the payment instrument unit with the vending machine, and a payment instrument unit comprising a connecting member for connecting the payment instrument unit with the corresponding member of the vending machine, and a means of communicating with the vending machine in accordance with the vending machine protocol characterized in that the said payment instrument unit comprises a first means that comprises a first data transfer device for receiving a contact request from wireless terminal equipment, and a second means comprising a second data transfer device for authenticating the user of the said wireless terminal equipment

The method for buying an item from a vending machine is characterized in that

I. Contact requests coming from terminal equipment are transmitted to a payment instrument unit located in the vending machine,

II. At a certain stage of a purchasing transaction, a contact request from the terminal equipment is received by the payment instrument unit,

III. The user of the said terminal equipment is authenticated,

IV. Specification of the item to be bought is acknowledged by the vending machine's user interface, and

V. Charging data are generated after the item has been specified.

In the method according to the invention, at a certain stage of a purchasing transaction, the buyer establishes a contact by wireless terminal equipment, such as a mobile station, with the payment instrument unit connected to the vending machine. Typically, the payment instrument unit is at least partly installed inside the vending machine. This contact can be made through a data transmission network such as a mobile station network or directly with the data transfer device of the payment instrument unit. If the data transmission network available supports direct communication between terminal equipments, a direct contact can be made via radio or, for example, by means of an infrared link. It is also possible that the payment instrument unit comprises a connector or a reader to which the mobile station can be temporarily connected. In that case, the front panel of the payment instrument unit can constitute part of the vending machine's front panel.

In the method according to the invention, the buyer transmitting the contact request is authenticated. This authentication can be effected indirectly by authenticating the mobile station used for the purchasing transaction, for example, or, to be more precise, the smart card contained by the mobile station. Authentication is effected in order to be able to charge the correct buyer for the price of the item. The payment instrument unit according to the invention can perform the authentication locally or by using the data transmission network. Local authentication can be effected, for example, by transmitting a challenge to the buyer/mobile station, which the buyer/mobile station then answers. To give a correct answer one needs a private key, which only the buyer knows and/or which is stored in the smart card of the mobile station. Authentication performed by using the data transmission network can also be based on the challenge-answering method, but then the payment instrument unit receives the challenge from the data transmission network and transmits the answer further to the data transmission network to be checked If the answer is correct, the data transmission network then transmits an acceptance message to the payment instrument unit If the buyer contacts the payment instrument unit through the data transmission network by using his or her mobile station, the data transmission network can authenticate the buyer/mobile station already at this stage. In that case, the contact request received by the payment instrument unit trough the data transmission network can also be an implicit acceptance message for authentication.

To charge for the item that is bought from the vending machine, the method according to the invention generates charging data. The charging data can be generated by the payment instrument unit or by the data transmission network; especially, if the contact request is made through the data transmission network. The mobile station can also generate charging data and transfer them through the data transmission network to be processed further. The charging data can be generated during the purchasing transaction or after the purchase. The charging data can be forwarded from the payment instrument unit through the data transmission network to be further processed. The invention does not take a stand as to which quarter processes the data or charges the buyer for the price of the item. The term ‘charging’ does not limit the methods or the devices according to the invention only to those that do not pay for the item until after the delivery. The charging data collected can also be used to reduce the balance of a prepaid card, for instance.

A certain available maximum balance can either be determined by the payment instrument unit according to the invention, or the available balance can be transmitted to the payment instrument unit through a data transfer connection. This data transfer connection is preferably the same as the one through which the contact request came to the payment instrument unit or the one through which the charging data are transmitted The user is charged neither for the said available maximum balance nor the correct price of the item until they have specified the desired item by the user interface of the vending machine. Thus, a mere contact request to a number or an address indicated by the vending machine does not cause the user any charges connected with the items in the vending machine. For the data transmission resources used, the user may have to pay the price of a local call

The payment instrument unit according to the invention is a device that can be connected to a vending machine. It can be installed inside the vending machine, for example. Typically, the payment instrument unit is connected to the connectors on the motherboard of the vending machine's central processor; by connecting the connectors of the payment instrument unit to the corresponding connectors of the central processor by using a suitable data transfer cable. When discussing with the vending machine, the payment instrument unit uses the standard vending machine protocols commonly used. The interface between the vending machine and the payment instrument unit according to the invention is thus precisely defined both in the functional and the physical sense: the vending machine and the payment instrument unit communicate by transmitting messages in accordance with a certain vending machine protocol over the interface; typically, in the order specified by the vending machine protocol and there are corresponding connectors in the payment instrument unit and the vending machine (on the motherboard of the vending machine's central processor). Typically, the vending machine protocol also specifies how to act in error situations.

In the method according to the invention or when using the payment instrument unit according to the invention, the actual specification of the item to be bought does not differ from the way used when paying by other payment instruments. The item is specified by means of the user interface of the vending machine with the intermediary of keys, a touch screen or voice commands. The item keys or corresponding parts of the vending machine's user interface, connected to the items that are within the balance of the payment instrument, can be activated after a contact request has arrived to make it easier to make a selection.

When using the payment instrument unit according to the invention and when the buyer is charged for the item by the method according to the invention, we do not have to in advance specify the items of the item range of the vending machine that are available. The user can choose from among all items, the price of which is less than the available balance. When paying by the payment instrument unit according to the invention, the item range can thus be the same as when using other payment instruments.

The item is delivered to the user from the vending machine according to the invention after they have specified the desired item. The specification is carried out by the vending machine's user interface. It is less likely to select a wrong item accidentally than in the case where the item is selected by a telephone number only. As he or she has to specify the item, the buyer cannot buy an item accidentally: a mere call to the telephone number of the vending machine does not induce charging and delivering an item It is not very easy to swindle the system by directing calls to the service number connected to the vending machine, because the swindler should be watching next to the vending machine m order to push a selection key to ensure the delivery of the item.

The items bought by using the payment instrument unit according to the invention are entered into the memory of the vending machine's central processor, and it is possible to follow the selling of the items in the same way as the items that are paid by other means of payment, as well as the sales thereof. Furthermore, the payment instrument unit according to the invention is in accordance with the vending machine standard and can thus be implemented without alterations that depend on the model or brand of the vending machine. The payment instrument unit according to the invention can be, for example, a device that comprises clips that are used to attach the payment instrument unit inside the vending machine, the clips, the external dimensions, and the data transmission connectors of the device being in accordance with certain standards. In that case, it is possible to easily replace the payment instrument unit of a vending machine that handles, for example, token coins with the payment instrument unit according to the invention, which makes it possible to pay for the items by using a mobile station.

In the following, the invention is described in more detail with reference to the preferred embodiments of the invention and the appended drawings, in which:

FIG. 1 shows a vending machine according to prior art and the purchase of an item specified and paid by using a mobile station,

Fig. 2 shows the progress of a purchasing transaction in a vending machine according to prior art,

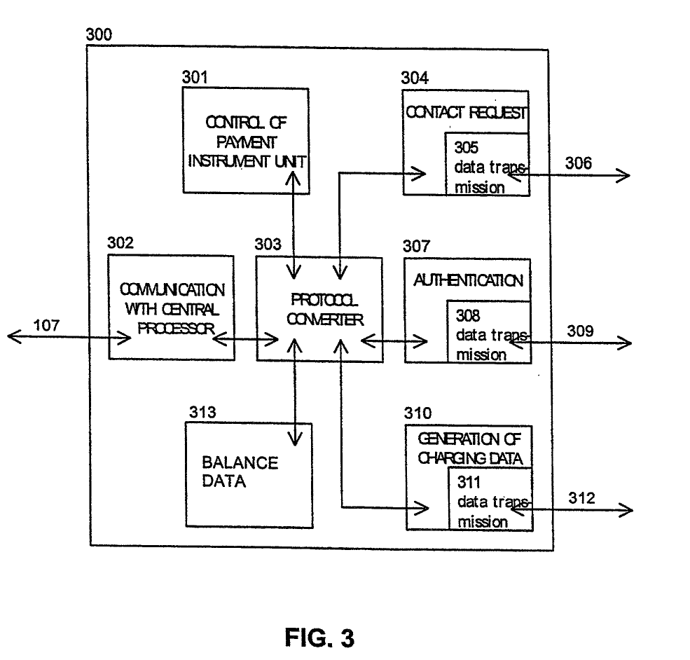

FIG. 3 shows the block diagram of the payment instrument unit according to the first preferred embodiment of the invention,

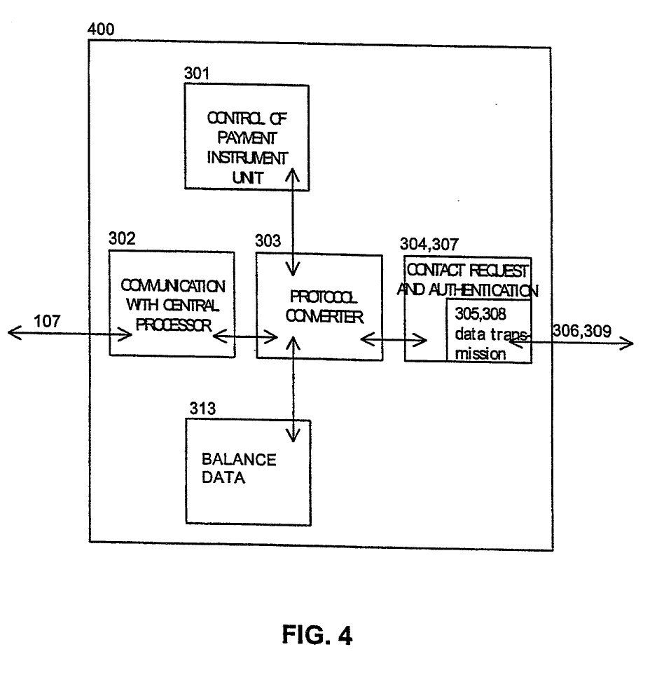

FIG. 4 shows the block diagram of the payment instrument unit according to the second preferred embodiment of the invention,

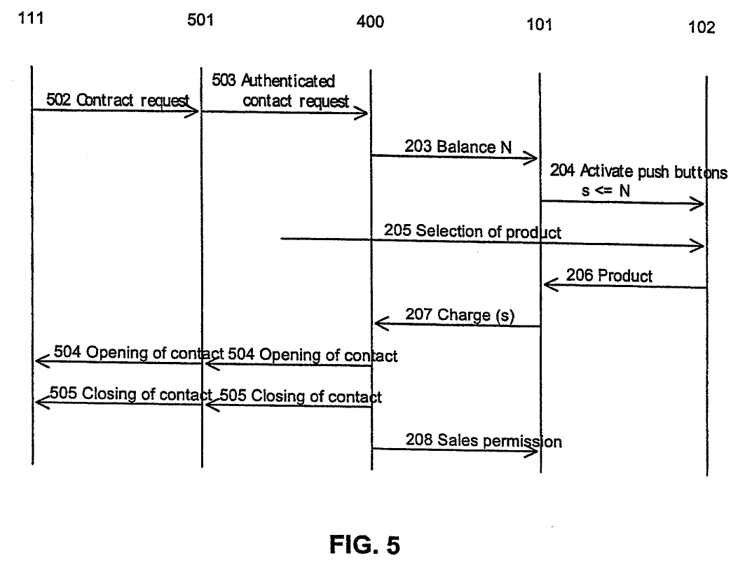

FIG. 5 shows the progress of a purchasing transaction, when the vending machine is provided with the payment instrument unit according to the second preferred embodiment of the invention,

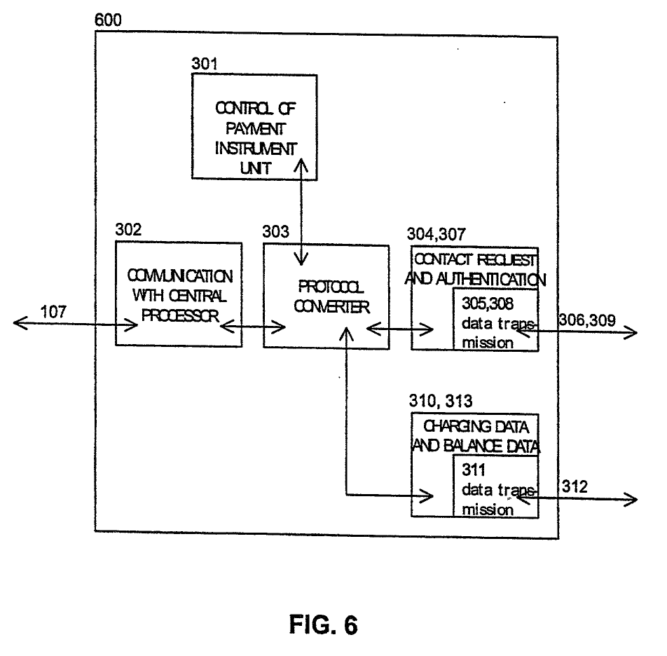

FIG. 6 shows the block diagram of the payment instrument unit according to the third preferred embodiment of the invention,

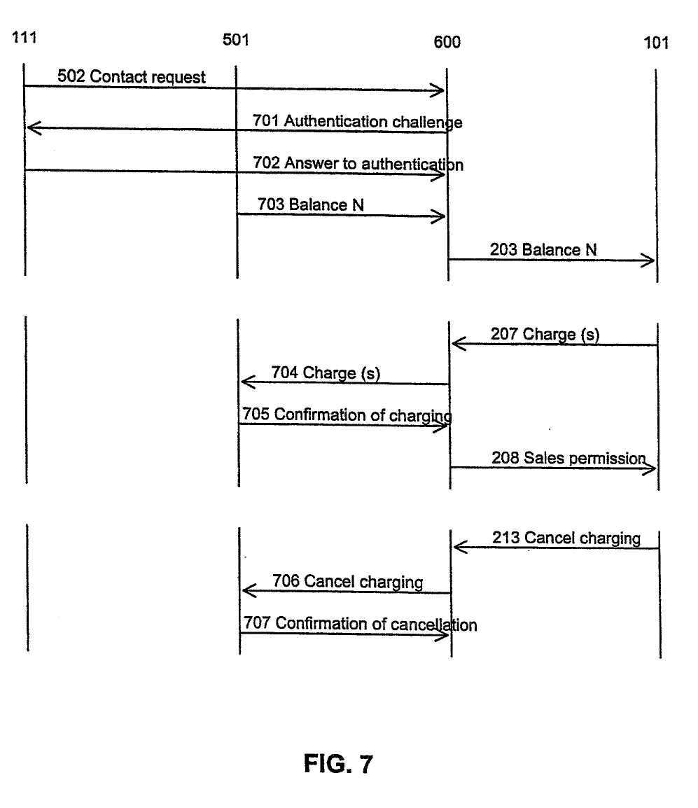

FIG. 7 shows the progress of a purchasing transaction, when the vending machine is provided with the payment intent unit according to the third preferred embodiment of the invention,

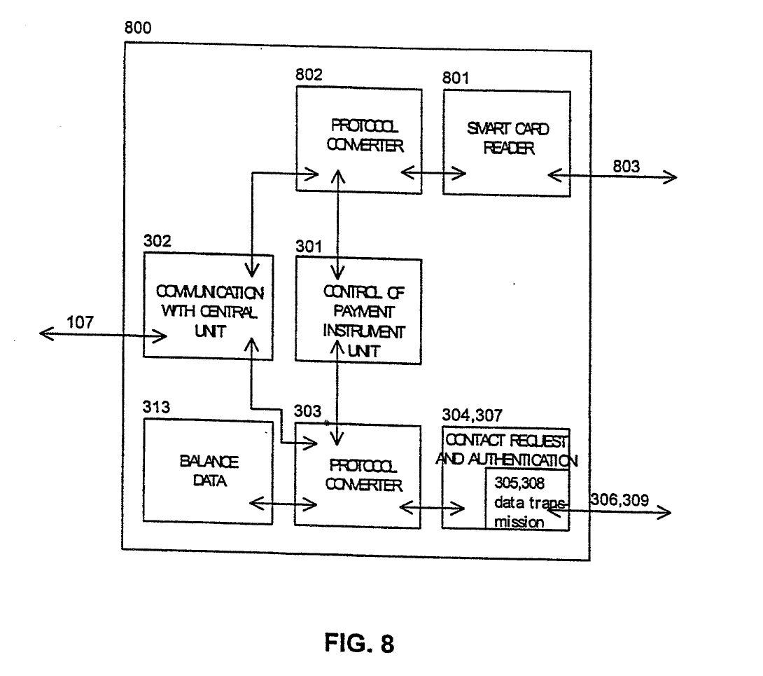

FIG. 8 shows the block diagram of the payment instrument unit according to the fourth preferred embodiment of the invention, and

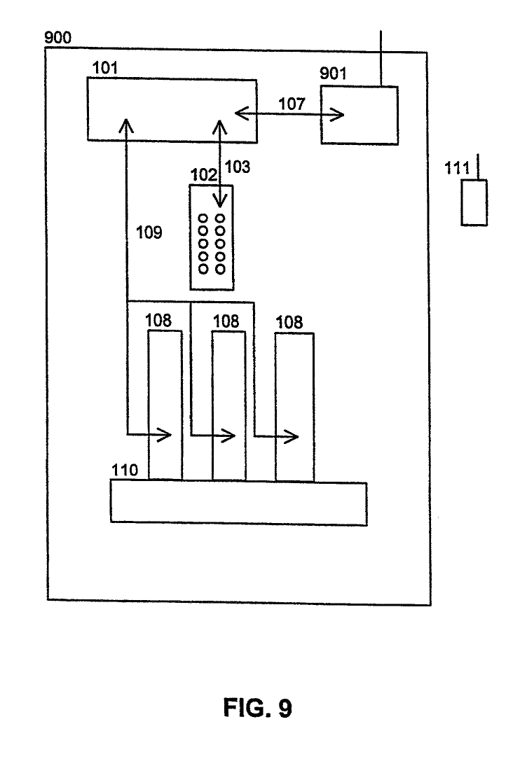

FIG. 9 shows the vending machine according to the invention.

In the figures, the same reference numbers are used for the parts corresponding to one another. We already referred to FIGS. 1 and 2 in the prior art description.

FIG. 3 shows the block diagram of the payment instrument unit according to the first preferred embodiment of the invention. Payment instrument unit 300 comprises control block 303 and block 302 that is in charge of communication 107 with the central processor of the vending machine. Block 302 in particular can be the same as those in prior art payment instrument units. Block 304 receives a contact request that a buyer transmits with their terminal equipment, and it is in charge of processing this contact request. The contact request message is transmitted to the payment instrument unit through data transmission block 305. When needed, protocol converter block 303 is responsible for converting the contact request into a message according to the vending machine protocol.

Block 307 is in charge of authenticating the buyer by authenticating, for example, the mobile station that made the contact or, more precisely, the smart card contained by the mobile station. The block comprises data transmission block 308 for transmitting the messages related to the authentication. Authentication can be effected without intermediaries between the payment instrument unit and the mobile station, so that authentication block 307, for example, comprises the required cryptographic functions. Another alternative is that authentication block 307 merely transmits authentication messages to the data transmission network or, through the data transmission network to a third party that is in charge of the required cryptographic functions. If both the contact request is received and the authentication is effected locally, data transmission devices 305 and 308 are preferably one device. If the contact request is carried out through the data transmission network, the data transmission network can, before transmitting the contact request to data transmission device 305, authenticate the mobile station that transmitted the contact request In that case, too, data mission devices 305 and 308 are preferably one device. Protocol converter block 303 is also in charge of possible conversions between the vending machine protocol and the authentication messages.

FIG. 3 also shows generation block 310 of the charging data, which, if responsible for generating the charging data, is located in the payment instrument unit The charging data generation block can comprise data transmission block 311, which can be used to transmit the charging data to be processed further. Protocol converter block 303 is also responsible for possible conversions between the vending machine protocol and the charging data.

Blocks 304 and 305 are necessary for the payment instrument unit according to the invention. FIG. 3 also shows block 313, which is in charge of the balance data and needed in the payment instrument unit according to the invention as well. This balance block 313 can have a certain balance available for all purchasing transactions set in it. It can also be, for example: either part of block 304, if the balance data are transmitted to the payment instrument unit by the same data transmission connection 306 as the contact request, or part of block 310, if the balance data are transmitted by the data transmission connection 312 used for transmission of the charging data.

FIG. 4 shows the block diagram of the payment instrument unit according to the second preferred embodiment of the invention. The buyer can use the data transmission network to contact this payment instrument unit according to the second preferred embodiment of the invention, and the data transmission network concerned is responsible for authenticating the buyer's terminal equipment. Furthermore, charging data are generated in the said data transmission network.

Payment instrument unit 400 comprises control block 301, communications block 302, and protocol converter block 303. It also comprises contact request block 304 and authentication block 307. In the following, when describing the preferred embodiments of the invention, we will use a mobile telephone network as an example of a data transmission network, and a telephone call as an example of a contact request Data transmission device 305 can be a data GSM device, and the contact request, for example, a call to a certain service number, from where the call is directed to the data transmission device 305 of the payment instrument unit However, these examples do not limit the methods or the devices according to the invention.

As contacts are made with the payment instrument unit according to the second preferred embodiment of the invention through a mobile telephone network, the mobile telephone network has authenticated the mobile station at least when it started to use the resources of the mobile telephone network, possibly even just before the contact request call was made. Authentication block 307 can thus comprise the means of receiving acceptance messages of authentication only. As it only comes, when a mobile station has been successfully authenticated, an incoming contact request can be considered this acceptance message. Data transmission devices 305 and 308 can thus be one device, and we can consider the contact request block 304 and the authentication block 307 to be fused together. This is shown in FIG. 4 by locating the processing of contact requests and the authentication of a buyer in the same block, which is masked by reference numbers 304 and 307.

When using the payment instrument unit according to the second preferred embodiment of the invention, the owner of the vending machine can in advance agree on the price of the call or other data transmission contact with the teleoperator. The price can be defined, for example, on the basis of how expensive items we want to sell by this payment method. In that case, the available balance has been stored in balance block 313 of payment instrument unit 400, which is about the same size as the agreed price of a call. For generating and processing the charging data, we can use, for example, the same functions that the data transmission operator uses in the network anyway. This type of a system is simple to implement and the introduction costs are not high.

Typically, the payment instrument unit according to the invention is a separate device. It comprises a data transmission connector that is used to connect the payment instrument unit to the vending machine's central processor. This data transmission connector is related to the operation of block 302 and the messages according to vending machine protocol 107 travel through this connector. The blocks shown in FIGS. 3 and 4 can be implemented in the form of a microprocessor and a program that controls its operation. Data transmission blocks 305, 308, and 311 can be implemented, for example, by using a modem connected to a fixed telephone network or a modem or a corresponding device that uses a mobile network for data transmission. Data transmission inside the payment instrument unit, for example, between the modem of the payment instrument unit and the microprocessor of the payment instrument unit, can be implemented by any conventional means known per se.

FIG. 5 shows, by way of an example, a diagram of the progress of a purchasing transaction, when payment instrument unit 400 of the second preferred embodiment of the invention is used. The diagram in FIG. 5 shows the messages related to a purchasing transaction between the following units: the user's mobile station 111 or other corresponding terminal equipment, data transmission network 501, payment instrument unit 400, the vending machine's central processor 101, and the vending machine's user interface 102. In FIG. 5, these units are shown by vertical lines, the messages between the units by horizontal lines, and the time order of the transactions goes from the upper edge of the figure towards the lower edge thereof.

The purchasing transaction shown in FIG. 5 starts when, by using their mobile station 111, the buyer sends contact request 502 through data transmission network 501 to payment instrument unit 400 of the vending machine. This contact request can be, for example, a call to a certain service number. An implicitly authenticated contact request 503 that comes to payment instrument unit 400 can be, for example, a signalling message of the mobile network, indicating the incoming call. Upon observing the implicitly authenticated contact request 503, payment instrument unit 400 converts this contact request into protocol message 203 according to protocol 107 used in the vending machine, indicating the available balance N to central processor 101.

After the arrival of protocol message 203, central processor 101 can activate those parts in the user interface, which are connected to the items that the available balance N can cover (arrow 204). The buyer specifies an item by pushing a button, for example. This is shown in FIG. 5 by arrow 205, the forward end of which is the user. The information about the specified item is transmitted to the central processor (arrow 206). When the central processor tells payment instrument unit 400 to charge for the price of the item (arrow 207), it answers the call (arrow 504) and then ends the call (arrow 505). This answer to the call induces the generation of charging data in the mobile network. Depending on the implementation, a connection can be opened all the way to mobile station 111 (arrow 504) or only to some network element located in the data transmission network.

The purchasing transaction shown in FIG. 5 progresses by sales permission message 208 that is sent by the payment instrument unit to the central processor. Thereafter, the item is delivered from the item bay to the compartment, from where the user can pick it up. These phases are not shown in FIG. 5.

When using payment instrument Aunt 400 according to the second preferred embodiment of the invention, it is thus possible to buy an item, the price of which is less than or as high as the maximum price determined in advance, but the charging data collected always gives this maximum price. Change can be returned to the user, for example, by using the payment instrument unit of the vending machine that handles coins. The payment instrument unit according to this embodiment cannot be used for sending, for example, the cancellation of charging in the event of malfunction. In the possible event of malfunction, however, the money can be returned to the user by using the payment instrument unit of the vending machine that handles coins.

The block diagram of the payment instrument unit of the third preferred embodiment of the invention is shown in FIG. 6. In addition to blocks 301, 302, and 303, payment instrument unit 600 comprises a charging data generation block 310, which, during a purchasing transaction, generates messages concerning the charging of the item, and transmits these messages to the data transmission network through data transmission device 311. As the available balance is obtained, by way of an example, from the party responsible for processing the charging data, balance block 313 is part of the charging data generation block 310. This is shown in FIG. 6 by marking the block in charge of the charging and the balance data by reference numbers 310 and 313.

During the purchasing transaction, the charging messages are transmitted to a third party responsible for the charging, which is, for example, part of the invoicing system of the data transmission network. Next, by way of an example, the buyer contacts the payment instrument unit directly with their mobile station either through the connector or the reader in data transmission device 305, or via radio. Authentication of the mobile station is also carried out locally, by way of an example, between the mobile station and the payment instrument unit, therefore, data transmission devices 305 and 308 are, by way of an example, one device. FIG. 6 shows, in one block marked by reference numbers 304 and 307, the functions responsible for processing and authenticating the contact request.

FIG. 7 shows a similar diagram as that in FIG. 5, concerning certain stages of a purchasing transaction, when payment instrument unit 600 according to the third preferred embodiment of the invention is used The purchasing transaction is started by contact request 502 sent by the buyer. This contact request can be carried out, for example, by pushing a mobile station into the connector in payment instrument unit 600, which induces a login message of communication. Thereafter, payment instrument unit 600 authenticates the mobile station. FIG. 7 shows the authentication of the mobile station with the aid of challenge 701 and answer 702.

FIG. 7 shows, by way of an example, how the available balance N is obtained from the party responsible for charging (arrow 703). Payment instrument unit 600 can, for example, ask the party responsible for charging for this balance data by using a message that has been used to identify the buyer. The buyer has perhaps agreed on with their mobile station teleoperator, as to the maxim prices of the items they want to purchase by using this method. If the balance is transmitted directly from the mobile station, it can be, for example, the remaining amount of the prepaid sum that the user has paid the mobile station operator in advance and which is stored on the smart card of the mobile station. The balance is transmitted by message 203 from payment instrument unit 600 to the vending machine's central processor 101.

When the purchasing transaction has progressed to the point of charging (arrow 207 in FIG. 7), payment instrument unit 600, through the data transmission networks transmits the information on the real price of the selected item to the party responsible for charging (arrow 704). After a possible acknowledgement (arrow 705), payment instrument unit 600 sends a sales permission (arrow 208) to the vending machine's central processor. If no problems occur when the item is delivered, the data transmission connection concerning the charging can be closed after a certain waiting period. The connection used for authentication can be closed immediately after the authentication messages.

The diagram in FIG. 7 also shows a potential problem. For example, if there are problems when delivering the item, item bay 108 transmits information about them to the vending machine's central processor 101 by a message that is in accordance with protocol 109 used between these units. Central processor 101 then tells payment instrument unit 600 to cancel charging (arrow 213), and the payment instrument unit can send cancellation message 706 through the open data transmission connection. The party responsible for charging can acknowledge the arrival of this message by sending message 707. If charging message 704 is not delivered to the party responsible for charging until after the purchasing transaction has ended, the cancellation message 706 of charging is not required. In that case, right after recording the price of the item for further processing, the payment instrument unit sends sales permission message 208.

Payment instrument unit 600 according to the third embodiment of the invention, in which messages 703, 704, 705, 706, and 707 are transmitted between the party responsible for charging and the payment instrument unit, can be implemented in a mobile network, for example. The charging messages can be transmitted as signalling messages of the mobile network or as short messages, or a data transmission connection can be opened for them. In principle, any connection, preferably a wireless data transfer connection, is suitable for transmitting these messages. This kind of transmission of charging data requires more extensive arrangements than when using the payment instrument unit of the second preferred embodiment of the invention, in which the charging data can be collected by using the existing charging and invoicing systems of telephone networks.

This payment instrument unit 600 according to the third preferred embodiment of the invention, which generates charging data concerning the items, can also be used so that a certain maximum price is charged for the items. In that case, message 704 does not necessarily contain information about the price (s) of the selected item. In the event of problems, however, it is possible to cancel charging.

The block diagram of payment instrument unit 800 of the fourth preferred embodiment according to the invention is shown in FIG. 8. This payment instrument unit comprises control block 301 common to all the payment instrument units, and block 302 that communicates with the vending machine's central processor. It also comprises protocol conversion block 303 and, by way of an example, the merged contact request and authentication blocks 304 and 307 according to the second preferred embodiment of the invention, as well as balance data block 313 containing a certain maximum balance. As all the possibilities presented in the general description of the invention to implement the processing of contact requests, authentication, and transmission of the balance data are possible, FIG. 8 shows this contact request and authentication block and the balance data block only by way of an example. Furthermore, the payment instrument unit according to the 'fourth preferred embodiment of the invention can also comprise charging data generation block 310.

Payment instrument unit 800 also comprises a means of processing another payment instrument FIG. 8 shows the blocks required for processing the payments effected by using a smart card. Smart card reader 801 and a possible protocol conversion block 802 connected with the smart card reader are responsible for the payments effected by using the smart card under the control of control unit 301. Arrow 803 describes the communication between the smart card and the smart card reader. Protocol conversion blocks 303 and 802 can also consist of one block The advantage of this payment instrument unit is that the same components can be utilized when paying by several means of payment In this way, we save on manufacturing costs and the number of payment instrument units.

FIG. 9 shows vending machine 900 according to the invention, comprising payment instrument unit 901, which the buyer can contact by their mobile station 111 or similar terminal equipment. Payment instrument unit 901 can be a payment instrument unit 300, 400, 600 or 800 according to any of the preferred embodiments of the invention described above. By way of an example, payment instrument unit 901 shown in FIG. 9 comprises a data transmission device, which is the terminal of a mobile station system. The payment instrument unit communicates with the vending machine's central processor 101 in accordance with vending machine protocol 107. When an item is bought from this vending machine according to the invention, the item is specified with the intermediary of user interface 102, and central processor 101 is responsible for controlling the action of item bays 108 by using connection 109. The central processor can maintain statistics about the items that are bought

The names of the messages in the description and the figures are only used by way of an example, and messages that are not essential to the invention are not shown. The names of the messages or the order of the messages presented do not limit the methods or the devices according to the invention to only concern the examples mentioned. There can be several messages or part of them can be missing, and the timing of the messages can vary. The term ‘message’ generally refers to various kinds of messages: for example, the term covers the signalling messages of the telephone network, short messages, and the messages specified for this purpose in particular, which travel, for example, in a packet switched network.

The data transmission network related to the payment instrument unit according to the invention is preferable a wireless mobile network. However, this does not set limits to the data transmission networks used with the payment instrument unit according to the invention, but all data transmission networks—whether circuit switched or packet switched networks or fixed or wireless networks—can be used.

The block diagrams of the payment instrument units according to the invention show the functional parts contained by the devices. However, the block diagrams do not define which part of the device according to the invention comprises the components related to the functions.

The references to the central processor, the user interface, and the other parts of the vending machine refer to logic units. Vending machines according to the invention or vending machines which have the payment instrument unit according to the invention attached thereto are not limited to devices that have a separate central processor or user interface. They can be integrated pus of the vending machine as well.

We claim:

1. A payment instrument unit connectable to a vending machine and, when connected to a vending machine, forming an integral part of the vending machine, comprising
a connecting member for connecting the payment instrument unit to a corresponding member of the vending machine, and
a means of communicating with the vending machine by using a certain vending machine protocol, wherein it comprises a first means comprising a first data transmission device for receiving a contact request from wireless terminal equipment, and a second means comprising a second data transmission device for authenticating the user of the said wireless terminal equipment.

2. A payment instrument unit according to claim 1, wherein said first data transmission device comprises at least one of the following means of direct communication with the wireless terminal equipment:
a means comprising a connecting member for temporarily connecting the said wireless terminal equipment to the payment instrument unit;
a means for communicating over an infrared link, or
a means for communicating via radio.

3. A payment instrument unit according to claim 1, wherein said first data transmission device is arranged to receive said contact request through a data transmission network.

4. A payment instrument unit according to claim 3, wherein said first data transmission device is a data transmission device of a cellular system or a fixed telephone system.

5. A payment instrument unit according to claim 1, wherein said first data transmission device is the same as said second data transmission device.

6. A payment instrument unit according to claim 1, wherein said first means or said second means are arranged to receive balance data.

7. A payment instrument unit according to claim 1, wherein it comprises a third means of generating charging data.

8. A payment instrument unit according to claim 7, wherein said third means are arranged to receive balance data.

9. A payment instrument unit according to claim 7, wherein said third means comprise a third data transmission device for transmitting the charging data.

10. A payment instrument unit according to claim 9, wherein said first data transmission device or second data transmission device are the same as said third data transmission device.

11. A payment instrument unit according to claim 1, wherein it comprises a fourth means for processing the payment instrument fed into the payment instrument unit and one means for communicating with said vending machine.

12. A payment instrument unit according to claim 11, wherein the first data transmission device and the second data transmission device consist of the same terminal equipment of a cellular system of a fixed telephone system, and said fourth means comprise a smart card reading device.

13. A vending machine comprising
a user interface for specifying the item to be bought,
a means for delivering the item,
a corresponding member for connecting a payment instrument unit to the vending machine, and
a payment instrument unit comprising a connecting member for connecting the payment instrument unit to the corresponding member of the vending machine, and a means for communicating with the vending machine in accordance with a vending machine protocol, said payment instrument unit forming an integral part of the vending machine when connected to it.

14. A method for buying an item from a vending machine, comprising
a contact request coming from the terminal equipment is transmitted to a payment instrument unit located in the vending machine, said payment instrument unit forming an integral part of the vending machine when connected to it and communicating with the vending machine in accordance with a vending machine protocol,
at a certain stage of the purchasing transaction, the payment instrument unit receives the contact request from the terminal equipment,
the user of the said terminal equipment is authenticated,
the specification of the item that is to be bought is acknowledged through the user interface of the vending machine, and
charging data are generated.

15. A method according to claim 14, wherein the charging data are generated after the item has been specified.

16. A method according to claim 14, wherein the user of the wireless terminal equipment is authenticated by authenticating said wireless terminal equipment.

17. A method according to claim 16, wherein said wireless terminal equipment is authenticated by using a data transmission network.

18. A method according to claim 17, wherein verification of authentication is transmitted to the payment instrument unit.

19. A method according to claim 18, wherein the contact request is transmitted to the payment instrument unit, which contact request is also verification of authentication.

20. A method according to claim 16, wherein said wireless terminal equipment is authenticated locally by the payment instrument unit.

21. A method according to claim 14, wherein said charging data are generated by the data transmission network.

22. A method according to claim 21, wherein said charging data are generated by such network elements of the cellular system or the fixed telephone system that generate the charging data of the cellular system or the fixed telephone system.

23. A method according to claim 14, wherein said charging data are generated by the said wireless terminal equipment.

24. A method according to claim 14, wherein said charging data are generated on the basis of the price of the item that is bought.

25. A method according to claim 14, wherein the balance data of the buyer are transmitted to the payment instrument unit.

26. A method according to claim 25, wherein said balance data are transmitted as signaling messages of a mobile station system or a fixed telephone system or as short messages of a mobile station system.

27. A method according to claim 14, in which charging for the item is canceled in certain situations, wherein said charging data are canceled.

28. A method according to claim 14, wherein calling a certain number is used as said contact request.

29. A method according to claim 14, wherein said contact request and/or said charging data are transmitted as signaling messages of a cellular system or a fixed telephone system or as short messages of a mobile station system.
